(19) United States
(12) Patent Application Publication
(10) Pub. No.: US 2018/0097429 A1
(43) Pub. Date: Apr. 5, 2018

(54) METHOD FOR PRODUCING A SHORT-CIRCUITING RING

(71) Applicant: WIELAND-WERKE AG, Ulm (DE)

(72) Inventors: Gerhard THUMM, Erbach (DE); Volker VOGGESER, Send en (DE)

(21) Appl. No.: 15/712,528

(22) Filed: Sep. 22, 2017

(30) Foreign Application Priority Data
Sep. 30, 2016 (DE) 10 2016 011 758.3

(51) Int. Cl. H02K 17/16; H02K 15/00; H02K 17/22

(52) U.S. Cl. CPC H02K 17/165; H02K 2213/03; H02K 17/22; H02K 15/0012

(57) ABSTRACT

The invention relates to a method for producing a short-circuiting ring (1) for a squirrel-cage rotor of an asynchronous machine, wherein the method comprises the following steps in the sequence mentioned:
a) providing material strips (2) from a metallic material;
b) vertically edge-rolling the material strips (2) such that open disk-shaped rings (31) are formed; and punching cut-outs (5) into the disk-shaped rings (3, 31, 32);
or
punching cut-outs (5) into the material strips (2), and vertically edge-rolling the material strips (2) such that open disk-shaped rings (31) are formed;
c) stacking the rings (3, 31, 32) such that the cut-outs (5) of all disk-shaped rings (3, 31, 32) are disposed in mutual alignment;
d) bundling the individual rings (3, 31, 32) by connecting neighboring rings (3, 31, 32).

The invention furthermore relates to a method for producing a short-circuiting ring (1) for a squirrel-cage rotor of an asynchronous machine, wherein the method comprises the following steps in the sequence mentioned:
a) providing a material strip (2) from a metallic material;
b) vertically edge-rolling the material strip (2) so as to form a helix (4); separating the metal strip (2) into a plurality of portions in such a manner that a stack of a plurality of open disk-shaped rings (31) is formed from the helix (4); and punching cut-outs (5) into the disk-shaped rings (3, 31, 32);
or
punching cut-outs (5) into the material strip (2); vertically edge-rolling the material strip (2) so as to form a helix (4); and separating the material strip (2) into a plurality of portions in such a manner that a stack of a plurality of open disk-shaped rings (31) is formed from the helix (4);
c) bundling the individual rings (3, 31, 32) by connecting neighboring rings (3, 31, 32).

### CROSS-REFERENCE TO RELATED APPLICATIONS

This claims priority from German Application No. 10 2016 011 758.3, filed Sep. 30, 2016, the disclosure of which is hereby incorporated by reference in its entirety.

### FIELD OF THE INVENTION

The invention relates to methods for producing a short-circuiting ring for a squirrel-cage rotor of an asynchronous machine.

A squirrel-cage rotor of an asynchronous machine comprises at least one bundle of laminations which has a multiplicity of clearances, and at least one squirrel cage from electrically conducting rotor bars which are incorporated in the clearances of the bundle of laminations such that the rotor bars at both end regions thereof have a projection beyond the bundle of laminations, and of short-circuiting rings that are attached to the bundle of laminations at the end side and have a multiplicity of cut-outs that are disposed in the region of the external circumference of said short-circuiting rings, the end regions of the rotor bars protruding into said cut-outs.

### BACKGROUND OF THE INVENTION

Various methods for producing the rotor squirrel cage are known. In some cases, the entire rotor squirrel cage is integrally cast. As modifications thereof, there are embodiments in which the rotor bars are made from a semi-finished product and are pushed into the clearances of the bundle of laminations. The short-circuiting rings are subsequently cast thereonto. By contrast, another variant provides that the short-circuiting rings are produced from correspondingly shaped disks. The disks must be connected to the rotor bars in a reliable manner that is highly conducting in electrical terms. In many cases, this is performed by a soldering process such as can be derived from publication DE 34 21 537 A1, for example. The annular disks are usually punched from a sheet metal panel. A comparatively large amount of punching scrap is created herein. Depending on the geometry of the disks, up to 50% of the sheet metal panel used ends up as scrap.

### SUMMARY OF THE INVENTION

The invention is based on the object of specifying improved methods for producing short-circuiting rings for a squirrel-cage rotor of an asynchronous machine.

The invention is represented by the features of claim 1 and by the features of claim 3. The further dependent claims relate to advantageous embodiments and refinements of the invention.

The invention includes a method for producing a short-circuiting ring for a squirrel-cage rotor of an asynchronous machine, wherein the method comprises the following steps in the sequence mentioned:
a) providing material strips from a metallic material;
b) vertically edge-rolling the material strips such that open disk-shaped rings are formed; and punching cut-outs into the disk-shaped rings;
or
punching cut-outs into the material strips, and vertically edge-rolling the material strips such that open disk-shaped rings are formed;
c) stacking the rings such that the cut-outs of all disk-shaped rings are disposed in mutual alignment;
d) bundling the individual rings by connecting neighboring rings.

The invention herein proceeds from the concept that the short-circuiting ring of a squirrel-cage rotor of an asynchronous machine is constructed from a plurality of disk-shaped rings which are stacked to form a bundle. A disk-shaped ring herein can be produced in a particularly material-saving and thus cost-effective manner in that a material strip from a metallic material is vertically edge-rolled so as to form a disk-shaped ring. The material strip provided is composed of a bar-shaped material. The cross-sectional shape of the material strip can be rectangular such that the material strip has a uniform thickness s. Alternatively, the cross-sectional shape of the material strip can be trapezoidal or wedge-shaped. In these cases, the thickness s of the material strip varies from a minimum value to a maximum value. The material strip has two rectangular upper sides, two parallel longitudinal sides with the length L, and two end side with the width B. The two end sides represent those ends by which the material strip in terms of the length thereof is delimited. The thickness s of the material strip is smaller than the width B of said material strip, and the length L of the material strip is larger than the width B of said material strip.

The material strip is composed of a metallic material which preferably comprises copper or a copper alloy. The material strip can be a monometal or can be assembled from a plurality of different metals. In particular, said material strip can be a bimetal strip.

When being vertically edge-rolled, the material strip is bent about a bending axis which is perpendicular to the upper side of the material strip.

The material strip herein is bent by approximately 360°, such that the two end sides of the material strip face one another. On account thereof, an open disk-shaped ring is formed. The external circumference of the ring is formed from the first longitudinal side of the material strip, the internal circumference of the ring being formed from the second longitudinal side of the material strip. The width of the ring corresponds to approximately the original width B of the material strip. The mean thickness of the disk-shaped ring is equal to approximately the mean thickness s of the material strip. In the case of a material strip having a trapezoidal or wedge-shaped cross section, the dissimilar elongations of the external strand and of the internal strand in the vertical edge-rolling of the material strip are compensated for by the trapezoidal or wedge-shaped cross section, such that the disk-shaped rings have an almost rectangular cross section.

In the case of a first embodiment of the method according to the invention, cut-outs are punched into each disk-shaped ring. These cut-outs serve for receiving the ends of rotor bars which are incorporated in the bundle of laminations of the squirrel-cage rotor and which at both ends have a projection beyond the bundle of laminations. These cut-outs are usually disposed close to the external circumference of the disk-shaped ring.

In the case of an alternative embodiment of the invention thereto, the methods steps of vertically edge-rolling and punching the cut-outs are carried out in reverse order. Herein, the required cut-outs are first punched into the material strips provided. These material strips by means of the vertical edge-rolling are subsequently shaped to form open disk-shaped rings.

After the method step b) a plurality of rings are stacked such that the cut-outs of all disk-shaped rings are disposed in mutual alignment. The number of the stacked disk-shaped rings is derived from the thickness of the individual rings and from the target thickness of the entire short-circuiting ring. The individual disk-shaped rings are subsequently bundled by connecting neighboring rings. Potential connecting methods include welding, crimping, riveting, or punch bundling. Welding can be performed on the external or on the internal circumference of the disk-shaped rings. It is also possible for the disk-shaped rings to be welded both on the external as well as on the internal circumference. Laser or electron-beam welding are preferred welding methods.

The particular advantage of the inventive method lies in that each material strip provided is completely shaped to form a disk-shaped ring. There is thus no scrap as is created when a disk-shaped ring is punched from a sheet metal panel, for example.

A material strip provided can advantageously have a chamfer on at least one longitudinal side. The vertical edge-rolling of the material strip is then performed in such a manner that the longitudinal side having the chamfer forms the external circumference of the disk-shaped ring. The chamfer extends into the material strip approximately so far that said chamfer upon punching of the cut-outs runs in the radial direction from the outer circumference of the disk-shaped ring up to the cut-outs. When disk-shaped rings having a chamfer of this type are stacked to form a short-circuiting ring, grooves are formed on the external circumference of the short-circuiting ring by the chamfers of neighboring rings. The grooves extend up to the cut-outs for the rotor bars. The grooves enable improved welding of the short-circuiting ring to the rotor bars.

In a preferred design embodiment of the invention, upon vertical edge-rolling of the material strips, the two ends of each material strip can be butt-welded to one another. The two end sides of each material strip are thus joined together in a planar manner. Closed disk-shaped rings are formed on account thereof. The closed disk-shaped rings have a particularly low electrical resistance. Said closed disk-shaped rings are furthermore very dimensionally stable. Therefore, this step is preferably performed prior to the punching of the cut-outs.

A further aspect of the invention includes an alternative method for producing a short-circuiting ring for a squirrel-cage rotor of an asynchronous machine. The method herein comprises the following steps in the sequence mentioned:
a) providing a material strip from a metallic material;
b) vertically edge-rolling the material strip so as to form a helix; separating the metal strip into a plurality of portions in such a manner that a stack of a plurality of open disk-shaped rings is formed from the helix; and punching cut-outs into the disk-shaped rings;
or
punching cut-outs into the material strip; vertically edge-rolling the material strip so as to form a helix; and separating the material strip into a plurality of portions in such a manner that a stack of a plurality of open disk-shaped rings is formed from the helix;
c) bundling the individual rings by connecting neighboring rings.

The invention herein proceeds from the concept that the short-circuiting ring of a squirrel-cage rotor of an asynchronous machine is produced from a material strip which by means of vertical edge-rolling is molded to a helical shape. The material strip provided is composed of a bar-shaped material. The cross-sectional shape of the material strip can be rectangular such that the material strip has a uniform thickness s. Alternatively, the cross-sectional shape of the material strip can be trapezoidal or wedge-shaped. In these cases, the thickness s of the material strip varies from a minimum value to a maximum value. The material strip has two rectangular upper sides, two parallel longitudinal sides with the length L, and two end sides with the width B. The length L of the material strip is significantly larger than the width B of said material strip. The thickness s of the material strip is smaller than the width B of said material strip.

The material strip is composed of a metallic material which preferably comprises copper or a copper alloy. The material strip can be a monometal or can be assembled from a plurality of different metals. In particular, said material strip can be a bimetal strip.

When being vertically edge-rolled, the material strip is bent about a bending axis which is perpendicular to the upper side of the material strip. The material strip herein is bent by an approximately integral multiple of 360°, such that a multi-tiered helix having an open core is formed. The number of tiers of the helix is derived from the mean thickness s of the material strip and from the target thickness of the entire short-circuiting ring. The cross-sectional shape of an individual tier of the helix results from the cross-sectional shape of the material strip provided. The external circumference of the helix is formed from the first longitudinal side of the material strip, the internal circumference of the helix being formed from the second longitudinal side of the material strip. In the case of a material strip having a trapezoidal or wedge-shaped cross section, the dissimilar elongations of the external strand and of the internal strand in the vertical edge-rolling of the material strip are compensated for by the trapezoidal or wedge shape, such that the individual tiers of the helix have an almost rectangular cross section.

Since one end of the material strip is located on each of the two end sides of the helix, the end sides of the helix upon vertical edge-rolling are not planar but each have a step. In order for this step to be removed, the helically bent material strip is separated into portions in such a manner that a stack of a plurality of open disk-shaped rings is formed from the helix. On account of the separation process, mutually opposite separation faces are created in pairs in each tier of the helix. The individual tiers of the helix are then deformed such that separation faces of originally neighboring helices are mutually opposite in pairs, and that disk-shaped rings are formed in this manner. In other words, one disk-shaped ring is formed from each tier of the helix, on account of which the steps on the end sides of the helix are removed. The end sides of a short-circuiting ring thus produced in this instance are planar, each forming a smooth bearing face.

In the case of a first embodiment of this method according to the invention, cut-outs are punched into the stacked disk-shaped rings. These cut-outs serve for receiving the ends of rotor bars which are incorporated in the bundle of laminations of the squirrel-cage rotor and which at both ends have a projection beyond the bundle of laminations. These cut-outs are usually disposed close to the external circumference of the disk-shaped ring.

In the case of an alternative embodiment of this inventive method, the method steps of vertically edge-rolling and punching the cut-outs are carried out in reverse order. Herein, the required cut-outs are first punched into the material strips provided. These material strips by means of vertical edge-rolling are subsequently shaped to form a helix.

The individual rings are finally bundled by connecting neighboring rings. Potential connecting methods include welding, crimping, riveting, or punch bundling. Welding can be performed on the external or on the internal circumference of the rings. It is also possible for the rings to be welded both on the external as well as on the internal circumference. Laser or electron-beam welding are preferred welding methods.

The particular advantage of the inventive method lies in that the material strip provided is completely shaped to form a disk-shaped ring. There is thus no scrap as is created when a disk-shaped ring is punched from a sheet metal panel, for example.

In a manner analogous to that of the first inventive method, the material strip provided in the case of this second alternative inventive method can also advantageously have a chamfer on at least one longitudinal side. The same advantages as have been described in the context of the first inventive method are derived therefrom.

In a preferred design embodiment of the invention, upon separating of the material strips into a plurality of portions, the two ends of each portion can be butt-welded to one another. The separation faces of originally neighboring helix tiers are thus joined together in a planar manner. Closed disk-shaped rings are formed from the open disk-shaped rings. The closed disk-shaped rings have a particularly low electrical resistance. Said closed disk-shaped rings are furthermore very dimensionally stable. Therefore, this step is preferably performed prior to the punching of the cut-outs.

Furthermore, in an advantageous embodiment of the invention, in order for a short-circuiting ring to be produced, in each case one inner cone can be embossed in the cut-outs for the rotor bars after the individual disk-shaped rings have been bundled. The rotor bars, on both ends thereof, in the case of this embodiment preferably have a corresponding outer cone. On account of this combination of an inner cone and an outer cone, the short-circuiting rings can be easily fitted to the bundle of laminations of the squirrel-cage rotor, since the ends of the rotor bars can be easily introduced into the cut-outs of the short-circuiting rings. Furthermore, a good mechanical connection between the short-circuiting rings and the rotor bars is guaranteed on account of the conical fit.

### BRIEF DESCRIPTION OF THE DRAWINGS

Exemplary embodiments of the invention will be explained in more detail by means of the schematic drawings in which:

FIG. 1 shows a material strip;

FIG. 2 shows an open disk-shaped ring having cut-outs;

FIG. 3 shows a closed disk-shaped ring having cut-outs;

FIG. 4 shows a short-circuiting ring that has been produced according to the first method;

FIG. 5 shows a further short-circuiting ring that has been produced according to the first method;

FIG. 6 shows a helix from a vertically edge-rolled material strip; and

FIG. 7 shows a short-circuiting ring that has been produced according to the second method.

### DETAILED DESCRIPTION

Equivalent parts are provided with the same reference signs in all figures.

FIG. 1 schematically shows a material strip 2 having the length L, the width B, and the thickness s. In the view illustrated, in each case one upper side 23, one longitudinal side 24, and one end side 25 of the material strip 2 are visible. The two end sides 25 form the two ends 21 and 22 of the material strip. Instead of the rectangular cross section, the material strip can alternatively also have a trapezoidal or wedge-shaped cross section. The thickness s in this instance would vary continuously along the width B.

FIG. 2 schematically shows an open disk-shaped ring 31 which by means of the vertical edge-rolling has been shaped from a material strip according to FIG. 1. The material strip has been bent by approx. 360°, such that the two ends 21 and 22 of the material strip 2 are mutually opposite. The disk-shaped ring 31 furthermore has cut-outs 5 such as are present once the method step b) of the first method according to the invention has been carried out.

FIG. 3 schematically shows a closed disk-shaped ring 32. Such a closed ring 32 is formed from an open ring 31 according to FIG. 2 in that the two ends 21 and 22 of the material strip are welded to one another. A weld seam 26 can be seen.

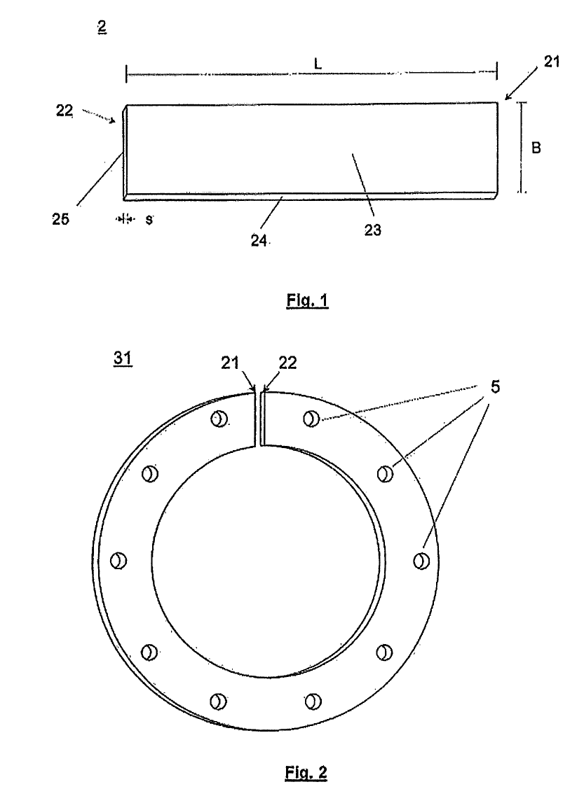

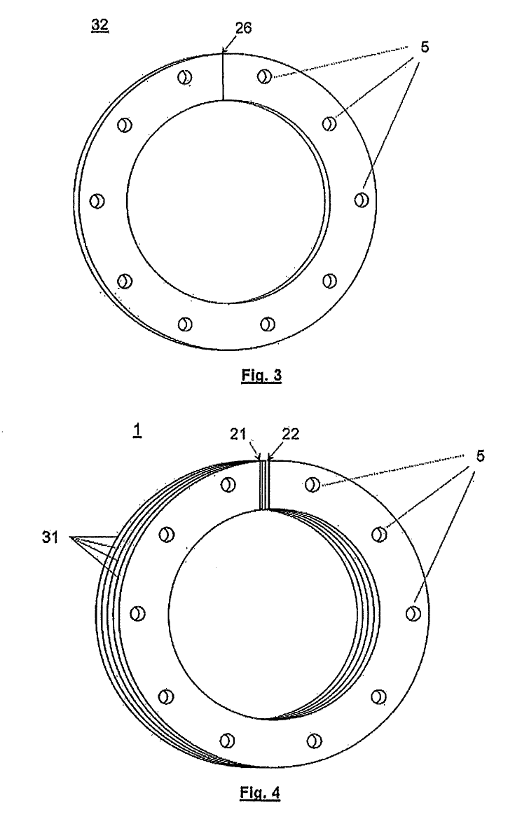

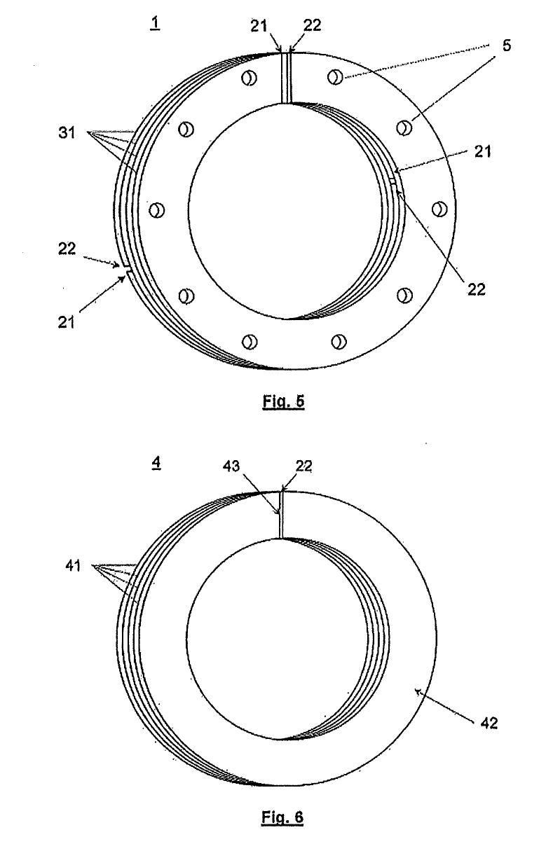

FIG. 4 schematically shows a short-circuiting ring 1 which has been produced by means of the first method according to the invention. In the case of the short-circuiting ring 1 illustrated, four open disk-shaped rings 31 according to FIG. 2 have been assembled so as to form a stack and been bundled by welding. The respective ends 21 and 22 of the material strips 2 are opposite one another in pairs. The four open disk-shaped rings 31 have been stacked such that the ends 21 and 22 of the material strips 2 are in each case positioned so as to be in the identical position in relation to the circumferential direction of the disk-shaped rings 31. The short-circuiting ring 1 furthermore has cut-outs 5.

FIG. 5 schematically shows a short-circuiting ring 1 in an embodiment that is modified in relation to that of the short-circuiting ring 1 illustrated in FIG. 4. The second open disk-shaped ring 31 in relation to the first open disk-shaped ring 31 has been rotated by 72° in the clockwise direction. The third open disk-shaped ring 31 in relation to the first open disk-shaped ring 31 has been rotated by 180° in the clockwise direction. The fourth open disk-shaped ring 31 in relation to the first open disk-shaped ring 31 has been rotated by 252° in the clockwise direction. On account of the rotation of the disk-shaped rings 31, the ends 21 and 22 of the material strips 2 have been distributed across the circumference of the short-circuiting ring 1. An embodiment of the short-circuiting ring 1 that is particularly stable in mechanical terms thus results.

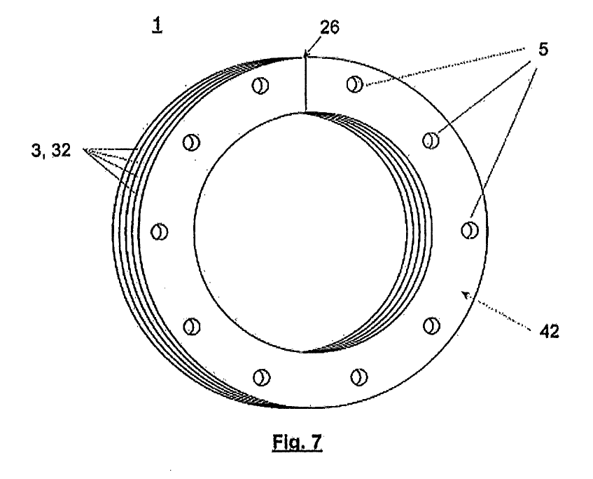

FIG. 6 schematically shows a helix 4 from a vertically edge-rolled material strip 2 according to FIG. 1. The helix 4 has four tiers 41. One end 22 of the material strip 2 can be seen at the visible end side 42 of the helix 4. The end 22 of the material strip 2 forms a step 43 on the end face 42 of the helix 4. The helix 4 that is illustrated in FIG. 6 corresponds to a state in which the vertical edge-rolling according to the method step b) of the second method according to the invention has already been carried out, but in which the separating of the material strip 2 into a plurality of portions, and the punching of cut-outs 5, has not yet been carried out.

FIG. 7 schematically shows a short-circuiting ring 1 which has been produced by means of the second method according to the invention. The helix 4 that is illustrated in FIG. 6 herein by a separation process has been disintegrated into portions in such a manner that disk-shaped rings 3 have been formed from the individual tiers 41 of the helix. The respective mutually opposite ends of the portions have been welded to one another such that closed disk-shaped rings 32 have been formed. A weld seam 26 can be seen. The end side 42 of the helix 4 as per this method step does not have any step. The short-circuiting ring 1 furthermore has cut-outs 5.

### LIST OF REFERENCE SIGNS

1 Short-circuiting ring

2 Material strip

21 End of the material strip

22 End of the material strip

23 Upper side of the material strip

24 Longitudinal side of the material strip

25 End side of the material strip

26 Weld seam

3 Disk-shaped ring

31 Open disk-shaped ring

32 Closed disk-shaped ring

4 Helix

41 Tier of the helix

42 End side of the helix

43 Step

5 Cut-out

L Length of the material strip

B Width of the material strip

s Thickness of the material strip

1. Method for producing a short-circuiting ring (1) for a squirrel-cage rotor of an asynchronous machine, wherein the method comprises the following steps in the sequence mentioned:
a) providing material strips (2) from a metallic material;
b) vertically edge-rolling the material strips (2) such that open disk-shaped rings (31) are formed; and
punching cut-outs (5) into the disk-shaped rings (3, 31, 32);
or
punching cut-outs (5) into the material strips (2), and vertically edge-rolling the material strips (2) such that open disk-shaped rings (31) are formed;
c) stacking the rings (3, 31, 32) such that the cut-outs (5) of all disk-shaped rings (3, 31, 32) are disposed in mutual alignment;
d) bundling the individual rings (3, 31, 32) by connecting neighboring rings (3, 31, 32).

2. Method according to claim 1, characterized in that, upon vertical edge-rolling of the material strips (2), the two ends (21, 22) of each material strip (2) are welded such that closed disk-shaped rings (32) are formed.

3. Method for producing a short-circuiting ring (1) for a squirrel-cage rotor of an asynchronous machine, wherein the method comprises the following steps in the sequence mentioned:
a) providing a material strip (2) from a metallic material;
b) vertically edge-rolling the material strip (2) so as to form a helix (4); separating the metal strip (2) into a plurality of portions in such a manner that a stack of a plurality of open disk-shaped rings (31) is formed from the helix (4); and punching cut-outs (5) into the disk-shaped rings (3, 31, 32);
or
punching cut-outs (5) into the material strip (2); vertically edge-rolling the material strip (2) so as to form a helix (4); and separating the material strip (2) into a plurality of portions in such a manner that a stack of a plurality of open disk-shaped rings (31) is formed from the helix (4);
c) bundling the individual rings (3, 31, 32) by connecting neighboring rings (3, 31, 32).

4. Method according to claim 3, characterized in that upon separating the material strip (2) into a plurality of portions, the two ends of each portion are welded such that closed disk-shaped rings (32) are formed from the open disk-shaped rings (31).
